(19) United States
(12) Patent Application Publication
(10) Pub. No.: US 2012/0125376 A1
(43) Pub. Date: May 24, 2012

(54) WET PROCESSING APPARATUS AND WET PROCESSING METHOD

(75) Inventors: Tadahiro Ohmi, Sendai-shi (JP); Tetsuya Goto, Sendai-shi (JP); Takaaki Matsuoka, Tokyo (JP); Takenao Nemoto, Tokyo (JP); Yoriyuki Murakawa, Kumamoto (JP); Kazuhiro Yoshikawa, Kumamoto (JP)

(73) Assignees: TOKYO ELECTRON LIMITED, Tokyo (JP); TOHOKU UNIVERSITY, Sendai-shi, Miyagi (JP)

(21) Appl. No.: 13/381,424

(22) PCT Filed: May 27, 2010
(86) PCT No.: PCT/JP2010/058993

§ 371 Date: Feb. 8, 2012

(30) Foreign Application Priority Data
Jul. 3, 2009 (JP) 2009-158885

(51) Int. Cl. B08B 7/00

(52) U.S. Cl. 134/33; 134/157

(57) ABSTRACT

A wet processing apparatus holds on a stage a substrate to be processed and carries out a wet treatment by rotating the stage. The substrate is held by the stage, with the center of the substrate being offset from the rotation center of the stage, using a Bernoulli chuck which causes an inert gas to flow to a back surface of the substrate, so that the substrate is eccentrically rotated along with the rotation of the stage. A first gas supply passage which is used for the Bernoulli chuck is provided at a rotation shaft portion in the stage and the stage is also provided with second gas supply passages which communicate with the first gas supply passage to thereby introduce the inert gas to the back surface of the substrate. The second gas supply passages are axisymmetric with respect to a central axis of the substrate.

### TECHNICAL FIELD

This invention relates to a wet processing apparatus and a wet processing method for wet-cleaning a semiconductor substrate or the like or etching it by a wet chemical solution.

### BACKGROUND ART

In the manufacture of a precision substrate of a semiconductor device or the like, wet treatment such as cleaning or etching is an indispensable process. In order to achieve the saving of a cleaning liquid and the saving of an occupation area of a cleaning apparatus, single-wafer wet processing apparatuses have been developed in recent years. In many of the single-wafer wet processing apparatuses, there is provided a rotary holding means which is rotatable and holds in a horizontal state a substrate to be processed. As disclosed in Patent Document 1, a Bernoulli chuck using the Bernoulli's theorem, which is capable of holding a substrate to be processed in a non-contact state with respect to a rotary stage, is effective as a method of holding the substrate.

The Bernoulli chuck chucks the substrate by causing a gas to flow from the center of the substrate toward the periphery of the substrate on a back surface (lower surface) of the substrate to thereby provide a negative pressure on the back surface of the substrate according to the Bernoulli's theorem. In order to achieve stable chucking by such a Bernoulli chuck, it is necessary to cause the gas to flow axisymmetrically from the central axis of the substrate. However, in this case, since the negative pressure is provided on the back surface of the substrate, the substrate is bent downward to be depressed due to the pressure difference between the front and back surfaces of the substrate.

### PRIOR ART DOCUMENT

### Patent Document

Patent Document 1: JP-A-2008-85242

### SUMMARY OF INVENTION

### Problem to be Solved by the Invention

There has been a problem that when a wet treatment liquid is supplied to the substrate whose central portion is slightly depressed due to the Bernoulli chuck, the wet treatment liquid stays in the central portion of the substrate so that the process uniformity of particularly the central portion of the substrate is degraded.

It is therefore an object of this invention to provide a wet processing apparatus and a wet processing method that can prevent degradation of the process uniformity of a substrate to be processed due to the use of a Bernoulli chuck.

### Means for Solving the Problem

According to a first aspect of this invention, there is provided a wet processing apparatus that holds on a stage a substrate to be processed and carries out a wet treatment by rotating the stage. In the wet processing apparatus, the substrate is held by the stage, with a center of the substrate being offset from a rotation center of the stage, using at least a Bernoulli chuck which causes a gas to flow to a back surface of the substrate, so that the substrate is configured to be eccentrically rotated along with rotation of the stage. A first gas supply passage which is used for the Bernoulli chuck is provided at a rotation shaft portion in the stage and the stage is also provided with second gas supply passages which communicate with the first gas supply passage to thereby introduce the gas to the back surface of the substrate, the second gas supply passages being axisymmetric with respect to a central axis of the substrate.

In the wet processing apparatus according to the above-mentioned aspect, preferable modes are as follows.

The Bernoulli chuck has a concave portion in a region on an upper surface of the stage and the region corresponds to a region including a central portion of the back surface of the substrate in a held state.

The concave portion is formed by a ring-shaped projection provided on the upper surface of the stage and the ring-shaped projection has a cross-sectional shape such that a distance between the substrate in the held state and an upper surface of the ring-shaped projection gradually decreases from an inner side toward an outer side of the substrate.

The first gas supply passage is formed axisymmetrically with respect to the center of the stage.

A plurality of fixed pins are provided on the stage at portions corresponding to the periphery of the substrate and the substrate is held at a predetermined position on the stage by the plurality of fixed pins.

A distance A between the rotation center of the stage and the center of the substrate and a diameter B of the substrate satisfy a relationship of A=C×B, where C=0.0375±0.0045.

Acccording to another aspect of this invention, there is provided a wet processing method which comprises introducing a gas for a Bernoulli chuck to a central portion in a rotary stage adapted to hold a substrate to be processed, through a first gas supply passage provided at a rotation shaft portion of the rotary stage; holding the substrate by supplying the introduced gas to a back surface side of the substrate through second gas supply passages which communicate with the first gas supply passage and are provided axisymmetrically with respect to a central axis of the substrate; rotating the rotary stage to eccentrically rotate the substrate in a state where a center of the substrate is offset from a rotation center of the rotary stage; and carrying out a wet treatment of the substrate in an eccentrically rotated state thereof.

In the wet processing method according to the above-mentioned other aspect, a preferable mode is as follows.

The method is characterized by forming a ring-shaped projection on an upper surface of the stage in a region corresponding to a region including a central portion of a back surface of the substrate in a held state and configuring a cross-sectional shape of the ring-shaped projection such that a distance between the substrate in the held state and an upper surface of the ring-shaped projection gradually decreases from an inner side toward an outer side of the substrate, thereby causing a flow velocity of the gas supplied to the back surface side of the substrate to be greater on the outer side of the substrate than on the inner side of the substrate.

According to this invention, the process uniformity is improved in a single-wafer substrate wet processing apparatus.

### BRIEF DESCRIPTION OF THE DRAWINGS

FIG. 1 shows a longitudinal sectional view (FIG. 1a) and a top view (FIG. 1b) of a peripheral portion of a stage of a wet processing apparatus to which this invention is applied.

FIG. 2 shows a longitudinal sectional view (FIG. 2a) and a top view (FIG. 2b) of the wet processing apparatus in which the stage shown in FIG. 1 is incorporated.

### MODE FOR CARRYING OUT THE INVENTION

### Embodiment

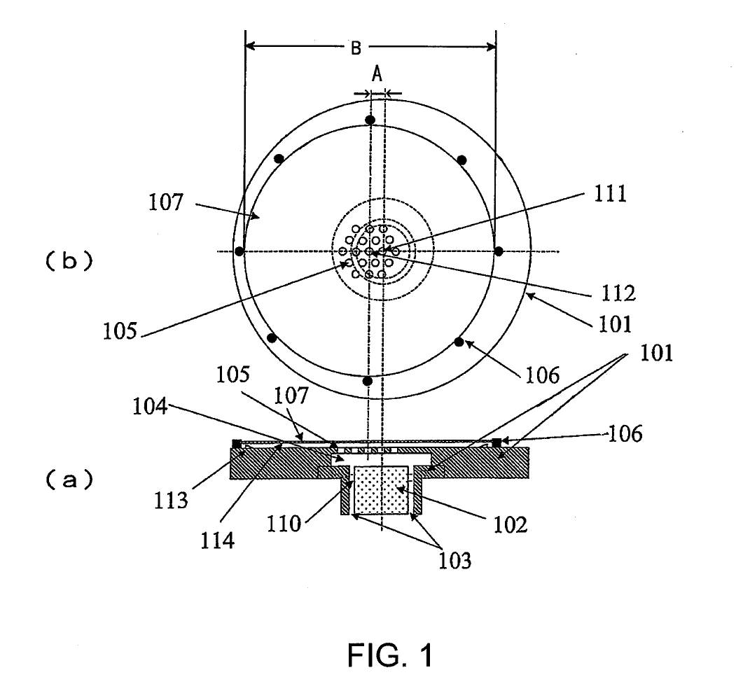

Referring to FIG. 1, a first embodiment of a wet processing apparatus according to this invention will be described. FIG. 1 shows a longitudinal sectional view (FIG. 1a) and a top view (FIG. 1b) of a peripheral portion of a stage of a wet processing apparatus having a Bernoulli chuck.

The wet processing apparatus holds on a circular stage 101 a circular substrate 107 to be processed, having a diameter of 300 mm, and carries out a wet treatment by rotating the stage 101. The stage 101 is rotated about a fixed central shaft 102. The center, denoted by 112, of the substrate 107 and the center, denoted by 111, of the stage 101 are distanced from each other by 11.25 mm. That is, the distance between the center 111 of the stage 101 and the center 112 of the substrate 107, i.e. an eccentric amount A, and the diameter B of the substrate 107 satisfy a relationship of A=C×B, where C=0.0375. 103 denotes an inlet for an inert gas which is used for the Bernoulli chuck. 110 denotes a first gas supply passage for the inert gas, herein a nitrogen gas, which is used for the Bernoulli chuck. The first gas supply passage 110 is surrounded by a cylindrical inner wall of a stage lower portion and an outer wall of the fixed central shaft 102, thereby forming a cylindrical space which is axisymmetric with respect to the center 111 of the stage 101.

The cylindrical first gas supply passage 110 communicates with a space 104 formed in the stage 101 at its central portion. Second gas supply passages 105 are formed through an upper wall, defining the space 104, of the stage 101. The second gas supply passages 105 are for introducing the inert gas for the Bernoulli chuck to a back surface of the substrate 107 placed on the stage 101. Herein, many holes each having a diameter of 3 mm are formed so as to be arranged substantially axisymmetrically with respect to the center 112 of the substrate 107.

The substrate 107 is held by the Bernoulli chuck and, simultaneously, is also held by a plurality of fixed pins 106 which are fixed on an upper surface of the stage 101 near its outer periphery. That is, the plurality of pins 106 projecting substantially vertically are circularly arranged near the outer periphery of the upper surface of the stage 101, thereby supporting the circumference of the substrate 107. The center of a circle formed by the plurality of pins 106 coincides with the center 112 of the substrate 107 to be supported. Further, a ring-shaped projection 113 is formed on the stage upper surface within the circle formed by the plurality of pins 106. At least the inner diameter of the ring-shaped projection 113 is smaller than the outer diameter of the substrate 107. The cross-sectional shape of the ring-shaped projection 113 is optional, but it is preferable that a gap between a ring-shaped projection upper surface and the substrate 107 gradually decrease from the inner side toward the outer side of the substrate 107. The stage 101 is rotated by a motor (illustration omitted) in the state where the substrate 107 is placed on the upper surface thereof.

This wet processing apparatus is characterized in that the rotation center 111 of the stage 101 and the center 112 of the substrate 107 are positioned so as to be offset from each other so that the substrate 107 is eccentrically rotated along with the rotation of the stage 101. The substrate 107 is placed on the upper surface of the stage 101 and then the stage 101 is rotated. In this state, the inert gas is introduced from the inert gas inlet 103, then through the first gas supply passage 110 and the space 104, the inert gas is ejected at a predetermined flow rate from the second gas supply passages 105 to the back surface (lower surface) of the substrate 107. Then, the substrate 107 is separated in a flying manner from the upper surface of the stage 101 and the ring-shaped projection 113, while the inert gas flows on the back surface of the substrate 107 from the second gas supply passages 105 in a gap 114 between the stage 101 and the substrate 107. Further, near the outer periphery of the substrate 107, the inert gas flows out to the circumference of the substrate 107 through the gap between the upper surface of the ring-shaped projection 113 and the substrate 107. In this event, since the gap between the substrate 107 and the stage 101 is relatively narrow, the flow velocity of the inert gas becomes relatively large and, particularly at the position of the ring-shaped projection 113, the gap between it and the substrate 107 becomes very small so that the flow velocity of the inert gas becomes very large.

On the other hand, after flowing to the outside of the substrate 107, the inert gas diffuses outward of the substrate 107 so that the flow velocity thereof becomes small. Therefore, according to the Bernoulli's theorem, the pressure on the back surface side (lower surface side) of the substrate 107 becomes negative as compared with that on the front surface side (upper surface side) of the substrate 107. As a result, the substrate 107 is sucked downward so as to be chucked in a non-contact state along the upper surface of the rotating stage 101. In particular, with the presence of the ring-shaped projection 113, the gas flow velocity becomes large at the position of the ring-shaped projection 113 as compared with a case of no ring-shaped projection and, therefore, the pressure difference between the back surface side and the front surface side of the substrate 107 also becomes large so that the force holding the substrate 107 becomes large.

The flow rate of the inert gas is a flow rate that allows the substrate 107 to produce a negative pressure according to the Bernoulli's theorem. The flow rate differs depending on the size and weight of the substrate 107, but is preferably about 50 liters/min when the substrate 107 is a silicon wafer having a diameter of 200 mm to 300 mm and a thickness of 0.7 mm.

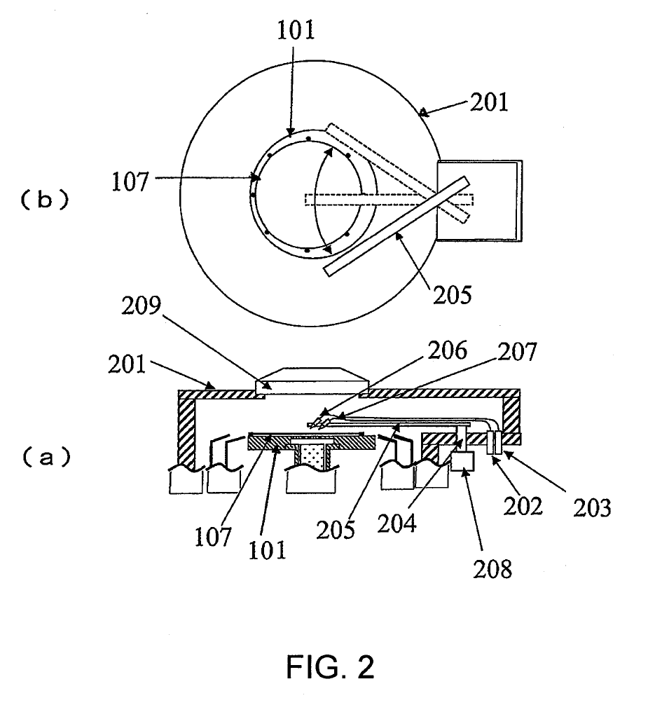

Next, referring to FIG. 2, a method of supplying a cleaning liquid to a substrate to be processed will be described in detail.

FIG. 2 shows a longitudinal sectional view (FIG. 2a) and a top view (FIG. 2b) of the wet processing apparatus in which the stage 101 shown in FIG. 1 is incorporated. In this embodiment, the stage 101 is received in a processing vessel 201. The processing vessel 201 has a shower plate 209 provided in its upper part. By supplying high-purity nitrogen or the like from the shower plate 209 into the processing vessel 201 isolated from the atmosphere, the wet processing apparatus can precisely control an atmosphere in the processing vessel 201. This makes it possible, for example, to prevent the formation of a natural oxide film on a wafer surface in silicon wafer cleaning.

Cleaning liquid supply pipes 202 and 203 are introduced in the processing vessel 201. The cleaning liquid supply pipes 202 and 203 are fixed to the upper side of a cleaning liquid ejection arm 205 which is made pivotable in the processing vessel 201 by means of a rotation support portion 204, and are respectively connected to upper nozzles 206 and 207 so as to be located above the substrate 107. A drive motor 208 is arranged below the rotation support portion 204 and, by driving the drive motor 208, the cleaning liquid ejection arm 205 makes a circular arc motion with respect to the rotation support portion 204 above the substrate 107. When a cleaning liquid is supplied from the cleaning liquid supply pipe 202, 203, the desired cleaning liquid can be ejected toward the surface to be cleaned of the substrate 107 from the upper nozzle 206, 207.

In this embodiment, high-rate etching of a silicon wafer was carried out. An etchant was a hydrofluoric/nitric/acetic acid solution (HF: 30 wt %, HNO₃: 21 wt %, CH₃COOH: 10 wt %, H₂O: 39 wt %). The stage 101 was rotated at 200 rpm, while the upper nozzle 206 was set at a position (height) of 90 mm from the silicon wafer and was caused to make a circular arc motion at 50°/sec. The temperature of the etchant was set to 30° C. The silicon wafer held over the stage 101 by the Bernoulli chuck was eccentrically rotated along with the rotation of the stage 101. By being eccentrically rotated, the central point of the silicon wafer constantly made a rotational (swing) motion with the eccentric amount (distance between the center of the stage 101 and the center of the silicon wafer) A=11.25 mm as a rotation (swing) radius. The etchant was supplied to the eccentrically rotating silicon wafer while causing the upper nozzle 206 to make the circular arc motion.

The present inventors have found that, as will be described hereinbelow, the etching rate uniformity is dramatically improved when the silicon wafer is eccentrically rotated as described above.

When a silicon wafer was rotated with an eccentric amount A=0 mm, i.e. with no eccentricity, the etching rate average value and the etching rate in-plane uniformity [defined by (etching maximum value−etching minimum value)/(etching average value)] in the silicon wafer were 192.8 μm/min and 128.1%, respectively. In particular, the etching rate was very high at the central point of the silicon wafer, which degraded the in-plane uniformity. This was caused by the fact that since the pressure is negative on a back surface of the silicon wafer due to the Bernoulli chuck, the silicon wafer is slightly bent so that its central portion is depressed as seen from a front surface of the silicon wafer, and therefore, that the etchant stays at the central portion of the silicon wafer so that the etching rate of the central portion increases as compared with that of a peripheral portion of the silicon wafer.

On the other hand, when a silicon wafer was eccentrically rotated with an eccentric amount A=11.25 mm, the etching rate average value and the etching rate in-plane uniformity were 188.0 μm/min and 47.1%, respectively, so that it was possible to improve the in-plane uniformity without so much reducing the etching rate.

Further, the present inventors have found that the effect of the improvement in in-plane uniformity is large when the eccentric amount A and the diameter B of the silicon wafer satisfy a relationship of A=C×B, where C=0.0375±0.0045. That is, by configuring such that the second gas supply passages 105 (FIG. 1) for introducing the gas to the back surface of the silicon wafer are axisymmetric with respect to the central axis of the silicon wafer to allow the silicon wafer to be bent and depressed with respect to the center of the silicon wafer, but being offset from the stage rotation center, thereby making the silicon wafer center (center of depression) and the stage rotation center offset from each other, it is possible to improve the etching rate uniformity. On the other hand, in order to supply the inert gas for the Bernoulli chuck to the upper surface of the stage 101 simply without making the stage rotating mechanism complicated, the first gas supply passage 110 is preferably axisymmetric with respect to the center 111 of the stage 101.

While the description has been given of the embodiment in which the etching rate uniformity is improved by eccentrically rotating the silicon wafer, it is needless to say that this invention is not limited to the above-mentioned embodiment. Various changes which can be understood by a person skilled in the art can be made to the structures and details of this invention within the spirit and scope of this invention as described in the claims.

What is claimed is:

1. A wet processing apparatus that holds on a stage a substrate to be processed and carries out a wet treatment by rotating the stage, wherein the substrate is held by the stage, with a center of the substrate being offset from a rotation center of the stage, using at least a Bernoulli chuck which causes a gas to flow to a back surface of the substrate, so that the substrate is configured to be eccentrically rotated along with rotation of the stage, and
a first gas supply passage which is used for the Bernoulli chuck is provided at a rotation shaft portion in the stage and the stage is also provided with second gas supply passages which communicate with the first gas supply passage to thereby introduce the gas to the back surface of the substrate, the second gas supply passages being axisymmetric with respect to a central axis of the substrate.

2. The wet processing apparatus according to claim 1, wherein the Bernoulli chuck has a concave portion in a region on an upper surface of the stage, the region corresponding to a region including a central portion of the back surface of the substrate in a held state.

3. The wet processing apparatus according to claim 2, wherein the concave portion is formed by a ring-shaped projection provided on the upper surface of the stage and the ring-shaped projection has a cross-sectional shape such that a distance between the substrate in the held state and an upper surface of the ring-shaped projection gradually decreases from an inner side toward an outer side of the substrate.

4. The wet processing apparatus according to claim 1, wherein the first gas supply passage is formed axisymmetrically with respect to the center of the stage.

5. The wet processing apparatus according to claim 1, wherein a plurality of fixed pins are provided on an upper surface of the stage at portions corresponding to the periphery of the substrate and the substrate is held at a predetermined position on the stage by the plurality of fixed pins.

6. The wet processing apparatus according to claim 1, wherein a distance A between the rotation center of the stage and the center of the substrate and a diameter B of the substrate satisfy a relationship of A=C×B, where C=0.0375±0.0045.

7. A wet processing method comprising:
introducing a gas for a Bernoulli chuck to a central portion in a rotary stage adapted to hold a substrate to be processed, through a first gas supply passage provided at a rotation shaft portion of the rotary stage;
holding the substrate by supplying the introduced gas to a back surface side of the substrate through second gas supply passages which communicate with the first gas supply passage and are provided axisymmetrically with respect to a central axis of the substrate;
rotating the rotary stage to eccentrically rotate the substrate in a state where a center of the substrate is offset from a rotation center of the rotary stage; and
carrying out a wet treatment of the substrate in an eccentrically rotated state thereof.

8. The wet processing method according to claim 7, characterized by forming a ring-shaped projection on an upper surface of the stage in a region corresponding to a region including a central portion of a back surface of the substrate in a held state and configuring a cross-sectional shape of the ring-shaped projection such that a distance between the substrate in the held state and an upper surface of the ring-shaped projection gradually decreases from an inner side toward an outer side of the substrate, thereby causing a flow velocity of the gas supplied to the back surface side of the substrate to be greater on the outer side of the substrate than on the inner side of the substrate.
